(19) United States
(12) Patent Application Publication
(10) Pub. No.: US 2002/0194975 A1
(43) Pub. Date: Dec. 26, 2002

(54) Saw blades with tiers of teeth

(76) Inventor: Ralph Carl Bishop, Shelter Island, NY (US)

Correspondence Address: Ralph Bishop, 2 Point lane, P.O. Box 875, Shelter Island, NY, 11964, US

(21) Appl. No.: 09/877,901

(22) Filed: Jun. 8, 2001

(51) Int. Cl. B23D 57/00

(52) U.S. Cl. 83/851; 83/848; 83/835

(57) ABSTRACT

This invention gives saw blades multiple tiers of saw teeth. Each tier of teeth is designed for and dedicated to a particular cutting characteristic. The first tier to engage the material being cut has fast cutting characteristics. Each subsequent tier cuts away the kerf surfaces left by the preceeding tier and cuts a new smoother kerf.

### CROSS REFERENCE TO RELATED APPLICATIONS

Not Applicable

### STATEMENT REGARDING FEDERALLY SPONSORED RESEARCH OR DEVELOPMENT

Not applicable

### REFERENCE TO A MICROFICHE APPENDIX

Not Applicable

### BACKGROUND OF THE INVENTION

The prior art saw blade is a cutting tool with a tier of cutting elements spaced at its foreword edge. Through the motion of the blade and pressure against the material addressed, the cutting elements, herein referred to as teeth, through a series of controlled superimposed scratches and scrapes perform a cutting action.

Saw tooth design evolves around creating configurations facilitating rapid advancement of cut, and configurations facilitating a smooth kerf. The design factors relating to speed, and the design factors relating to smoothness of cut, for a single tier of teeth are, however, mutually exclusive. A design compromise is struck so that there is an acceptable amount of each. The optimal potential for speed and or smoothness is not realized.

I am aware of the prior art patent to Romolo Messina et al. U.S. Pat. No. 5,197,453. The two tiers of cutting elements of this patent, however, do not relate to a refinement of cutting action as my invention does, rather, they relate to a grinding action giving a groove in concrete a particular configuration.

### BRIEF SUMMARY OF THE INVENTION

Through this invention the optimal potential of a saw blade's cutting action is realized through the placement of saw teeth on a plurality of tiers. The design compromises inherent in single-tier configurations are not required. The teeth of each tier are chosen from design configurations dedicated exclusively to the function of advancing the cut rapidly, or to the function of producing a smooth kerf. The teeth of the first tier, the most foreword, are uniformly spaced at the extreme edge of the blade, and are first to engage the material being cut. The configuration of these teeth is chosen from designs giving them the means for the fast advancement of the cut. They advance rapidly but produce coarse kerf surfaces. The teeth of the next tier to engage the material being cut have configurations chosen from designs giving them the means for producing a smooth kerf. These teeth are uniformly spaced and each tooth is placed between two teeth of the most foreward tier. All teeth are separated by gullets. The smooth kerf cutting tier of teeth project laterally further from the right and left side of the blade than the lateral projection from the right and left side of the blade of the most foreword tier of teeth. They cut away the coarse kerf surfaces left by the most foreward tier of teeth.

### BRIEF DESCRIPTION OF THE SEVERAL VIEWS OF THE DRAWING

FIG. 1 is a partial view of the side of a circular saw blade according to this invention.

FIG. 2 is a partial view of the side of a band or a straight saw blade according to this invention.

FIG. 3 is a view in detail of the portion indicated by section lines 3-3 in FIGS. 1 and 2 as saw teeth advance into material being cut.

### DETAILED DESCRIPTION OF THE INVENTION

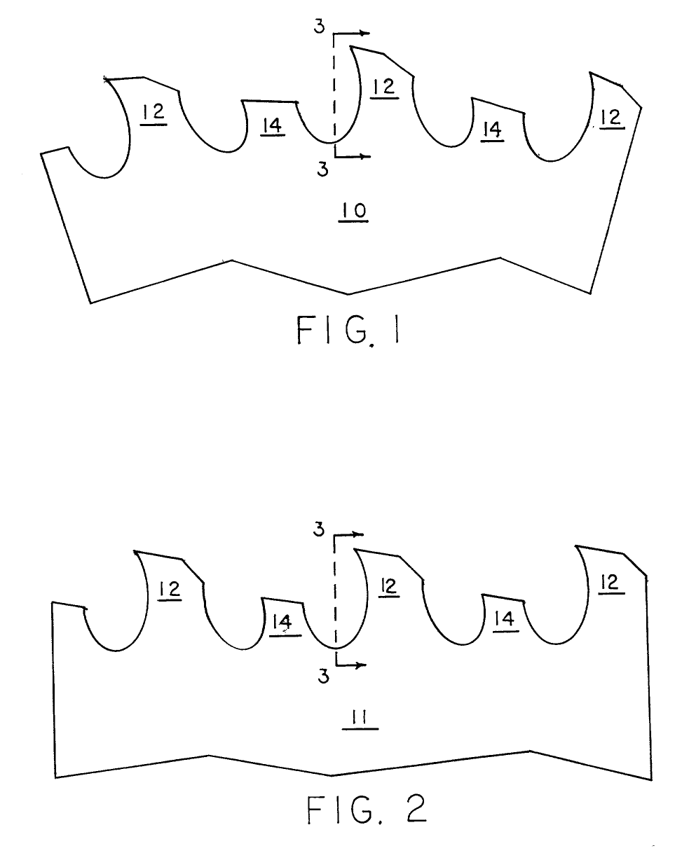

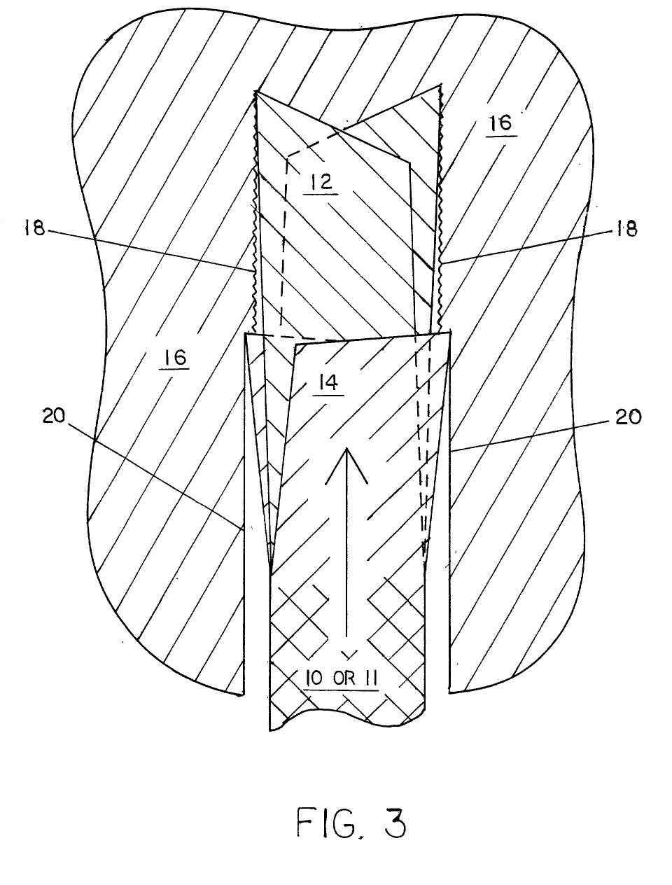

FIGS. 1 and 2 illustrate two tiers of prior art saw teeth on a circular saw blade 10 or a band or straight saw blade 11. The first, the most foreword tier of saw teeth 12, are first to engage the material being cut and have teeth with configurations chosen from designs giving them the means for achieving fast advancement of cut. The second tier of saw teeth 14 are set back from the first tier of saw teeth 12 and have teeth with configurations chosen from designs giving them the means for cutting a smooth kerf.

FIG. 3 illustrates the first tier 12 and the second tier 14 on a circular saw blade 10 or a band or straight saw blade 11 advancing into material being cut 16. The first tier of teeth 12 is dedicated to the means for achieving fast advancement of cut and leaves a coarse kerf surface 18. The second tier of saw teeth 14 is dedicated to the means for cutting smooth kerf surfaces and projects laterally into the coarse kerf surface 18 and cuts away the coarse kerf surface 18 while cutting a new smoother kerf surface 20.

Accordingly, the reader will see that saw blades with two tiers of teeth having each tier dedicated to a particular function will facilitate the maximum performance of all teeth. The design compromises inherent in the tooth configurations of single tier cutting-element saw blades are not necessary. With two tiers of teeth a saw blade functions more efficiently than it would with one.

Although the description above contains specifities these should not be construed as limiting the scope of the invention but as merely providing an illustration of a particular embodiment. For example:

A progression of more than two tiers of saw teeth on a saw blade with each tier after the first dedicated to the function of cutting smoother kerf surfaces than the kerf surfaces cut by the preceding tier will produce smoother kerfs still.

REFERENCE NUMBERS

| | |
|---|---|
| 10 | saw blade, circular |
| 11 | saw blade, band or straight |
| 12 | most foreword tier of saw teeth |
| 14 | the second tier of saw teeth |
| 16 | material being cut |
| 18 | coarse kerf surface |
| 20 | new smoother kerf |

What I claim as my invention is:

1 A saw blade with tiers of cutting teeth with, the configuration of the teeth of the first tier of teeth, the tier at the most foreword cutting edge of the blade, chosen from designs giving them the means for fast advancement into the material being cut with,
the second tier of teeth, the tier stepped back from the first, projecting laterally further from the right side and left side of the blade than the lateral right side and left side projections from the blade of the first tier of teeth with,
the configuration of the teeth of the second tier of teeth, chosen from designs giving them the means to cut smooth kerf surfaces, whereby,
the right and left side kerf surfaces cut by the first tier of teeth are cut away by the second tier of teeth as the second tier of teeth cut new smoother kerf surfaces.

2 The saw blade of claim 1 wherein all teeth are separated by gullets.

3 The saw blade of claim 1 wherein the blade is a circular saw blade.

4 The saw blade of claim 1 wherein the blade is a band saw blade.

5 The saw blade of claim 1 wherein the blade has a strait cutting edge.

6 The saw blade of claim 1 wherein there are a plurality of tiers of teeth in addition to the tier at the most foreword cutting edge of the blade with,
the right and left side lateral projections from the blade, of each tier becoming progressively greater as these tiers are distanced from the most foreword cutting edge of the blade with,
the configuration of the teeth of each tier chosen from designs giving each tier the means to cut a smoother kerf surface than that cut by the preceding tier of teeth, whereby,
a series of progressively smoother kerfs are cut.

7 The saw blade of claim 6 wherein all teeth are separated by gullets.

8 The saw blade of claim 6 wherein the blade is a circular saw blade.

9 The saw blade of claim 6 wherein the blade is a band saw blade.

10 The saw blade of claim 6 wherein the blade has a straight cutting edge.
